(19) United States
(12) Patent Application Publication
(10) Pub. No.: US 2026/0268591 A1
(43) Pub. Date: Sep. 10, 2026

(54) DISPLAYING VIRTUAL OBJECTS USING DYNAMIC SHADING

(71) Applicant: thinAir Technologies, Inc., Covington, LA (US)

(72) Inventor: Jeremey Charbonnet, Covington, LA (US)

(21) Appl. No.: 19/555,308

(22) Filed: Mar. 3, 2026

Related U.S. Application Data
(60) Provisional application No. 63/767,873, filed on Mar. 6, 2025.

(51) Int. Cl. G06T 15/80; G06F 3/01; G06T 15/00; G06T 15/08

(52) U.S. Cl. CPC G06T 15/80; G06F 3/013; G06T 15/005; G06T 15/08

(57) ABSTRACT

A method includes determining a first point-of-view (POV) of a two-dimensional (2D) image in a virtual environment from a user location characterized by a set of coordinates in the virtual environment and a distance between the 2D image and the user location. The method includes applying a first shading pattern to the 2D image based on the first POV in order to make the 2D image appear as a three-dimensional (3D) virtual object from the first POV. The method includes, in response to a change from the first POV to a second POV, determining a second shading pattern based on the second POV in order to make the 2D image appear as the 3D virtual object from the second POV. The method includes displaying, on the display, the 2D image with the second shading pattern.

### CROSS-REFERENCE TO RELATED APPLICATIONS

This application claims priority to U.S. Provisional Patent App. No. 63/767,873, filed on Mar. 6, 2025, which is hereby incorporated by reference in its entirety.

### TECHNICAL FIELD

The present disclosure generally relates to displaying virtual objects using dynamic shading.

### BACKGROUND

Some devices include a display. Some devices display virtual objects on the display. Displaying virtual objects can be resource-intensive. For example, rendering virtual objects in three dimensions (3D) is power-intensive. As such, rendering virtual objects in3D can drain a battery of a battery-operated device and cause excessive heating in a portable electronic device.

### SUMMARY

Various implementations disclosed herein include devices, systems, and methods for displaying virtual objects using dynamic shading. In some implementations, a device includes a display, an input device, one or more processors and a non-transitory memory. In various implementations, a method includes determining a first point-of-view (POV) of a two-dimensional (2D) image in a virtual environment from a user location characterized by a set of coordinates in the virtual environment and a distance between the 2D image and the user location. In various implementations, the method includes applying a first shading pattern to the 2D image based on the first POV in order to make the 2D image appear as a three-dimensional (3D) virtual object from the first POV. In various implementations, the method includes, in response to a change from the first POV to a second POV, determining a second shading pattern based on the second POV in order to make the 2D image appear as the 3D virtual object from the second POV. In various implementations, the method includes displaying, on the display, the 2D image with the second shading pattern.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1H are diagrams of an example environment in accordance with some implementations.

FIG. 2A is a block diagram of a system that utilizes dynamic shading in accordance with some implementations.

FIG. 2B is a diagram that illustrates dynamic shading patterns in accordance with some implementations.

FIG. 3 is a flowchart representation of a method of dynamic shading in accordance with some implementations.

FIG. 4 is a block diagram of a device that implements dynamic shading in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

Volumetric virtual objects are resource intensive to render continuously. As a result, as a number of volumetric virtual objects in a scene increases the frame rate typically has to drop to accommodate increasing numbers of volumetric virtual objects. Decreasing the frame rate adversely impacts a user experience provided by the device. Furthermore, continuously utilizing a renderer to render virtual objects in three dimensions (3D) increases a utilization of computing resources. Increased utilization of computing resources drains a battery of a battery-operated device. Moreover, continuously utilizing the renderer to render virtual objects in 3D tends to result in overheating of the device. The overheating is exacerbated for portable electronic devices with limited heat dissipation capabilities, in particular for wearable electronic devices such as a head-mountable device (HMD) which becomes unusable in a safe manner when overly-hot.

The present disclosure provides methods, systems, and/or devices for displaying virtual objects using fewer computing resources. Instead of always rendering a virtual object in 3D, a device sometimes displays a two-dimensional (2D) image that represents the 3D virtual object. The device applies a suitable shading pattern to the 2D image in order make the 2D image look similar to the 3D virtual object that the 2D image represents. The device varies the shading pattern based on a distance between the 2D image and a point-of-view (POV) corresponding to a user location. Dynamically changing the shading pattern that is applied to the 2D image makes the 2D image appear as the 3D virtual object that the 2D image represents. Changing the shading pattern that is applied to the 2D image is computationally cheaper than using a renderer to render the representative 3D virtual object in 3D. Since dynamically shading the 2D image has a lower computational overload than rendering the 3D virtual object, changing the shading pattern uses less power than 3D rendering of the virtual object. As such, dynamically applying a shading pattern to the 2D image extends a battery life of a battery-operated device. Furthermore, since dynamically shading the 2D image uses less graphics processing resources than 3D rendering, changing the shading pattern results in less heat generation which allows the user of an HMD to use the HMD in a safe manner for a prolonged period of time thereby improving a functionality of the device.

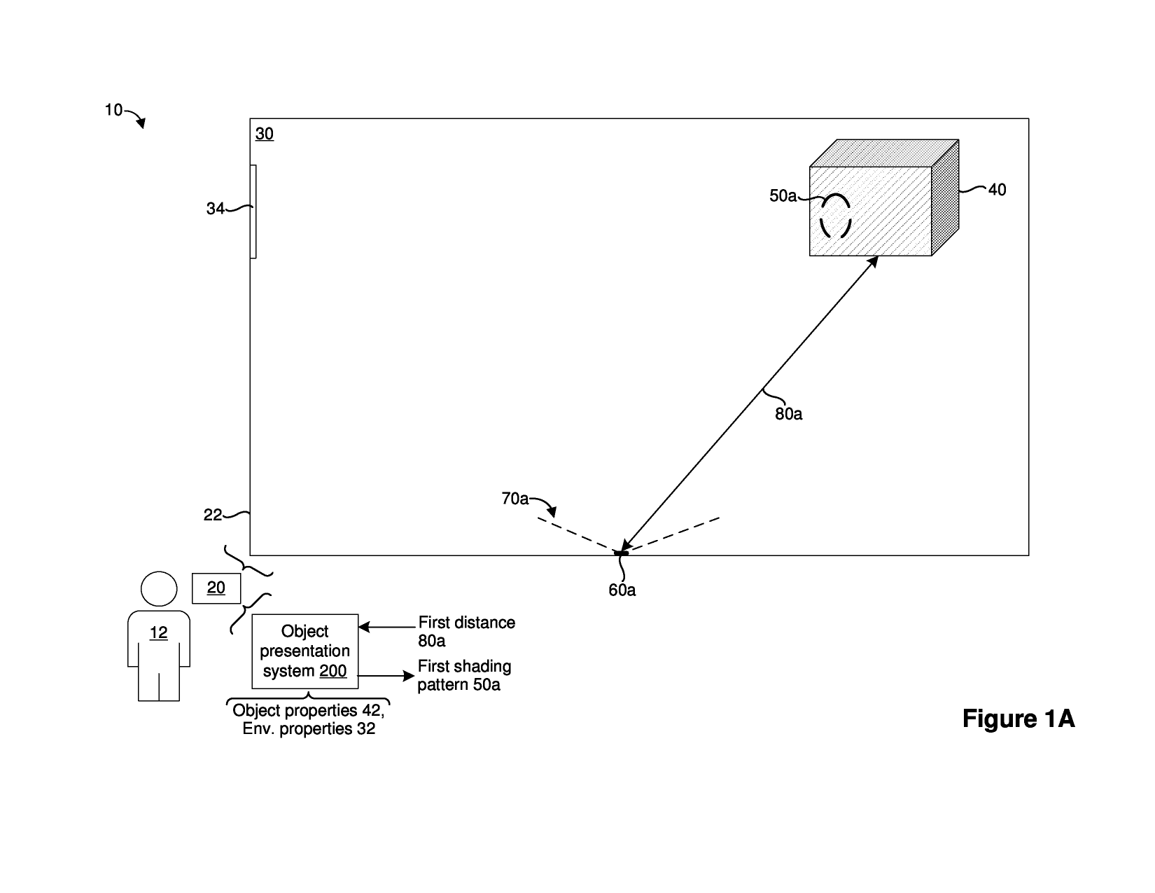

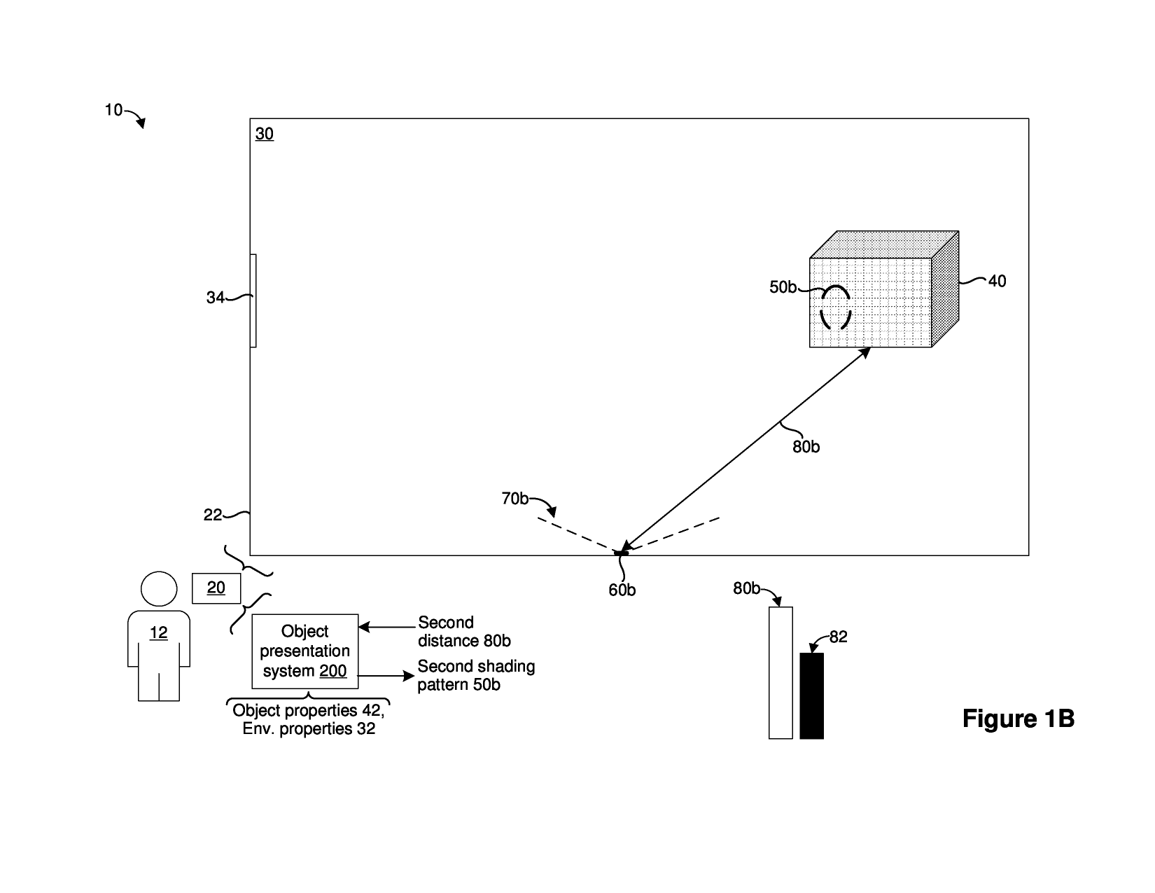

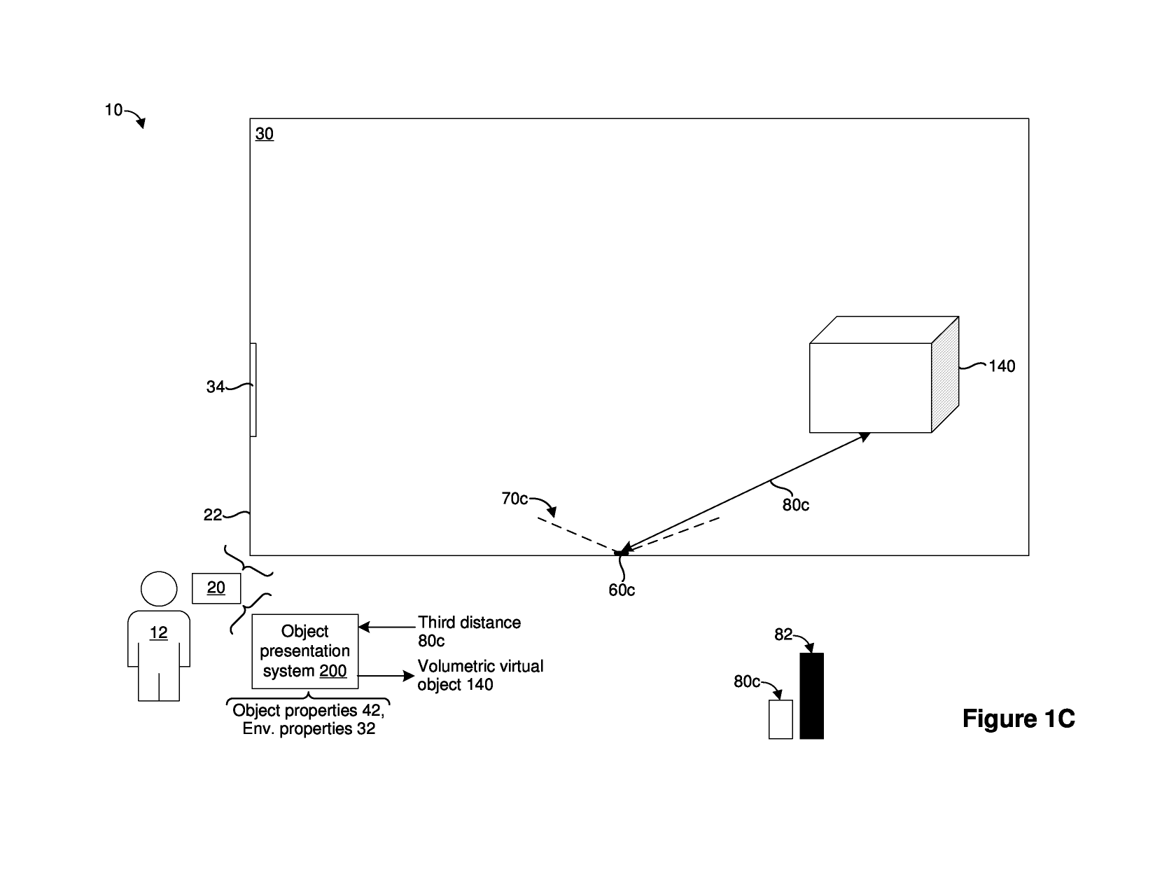

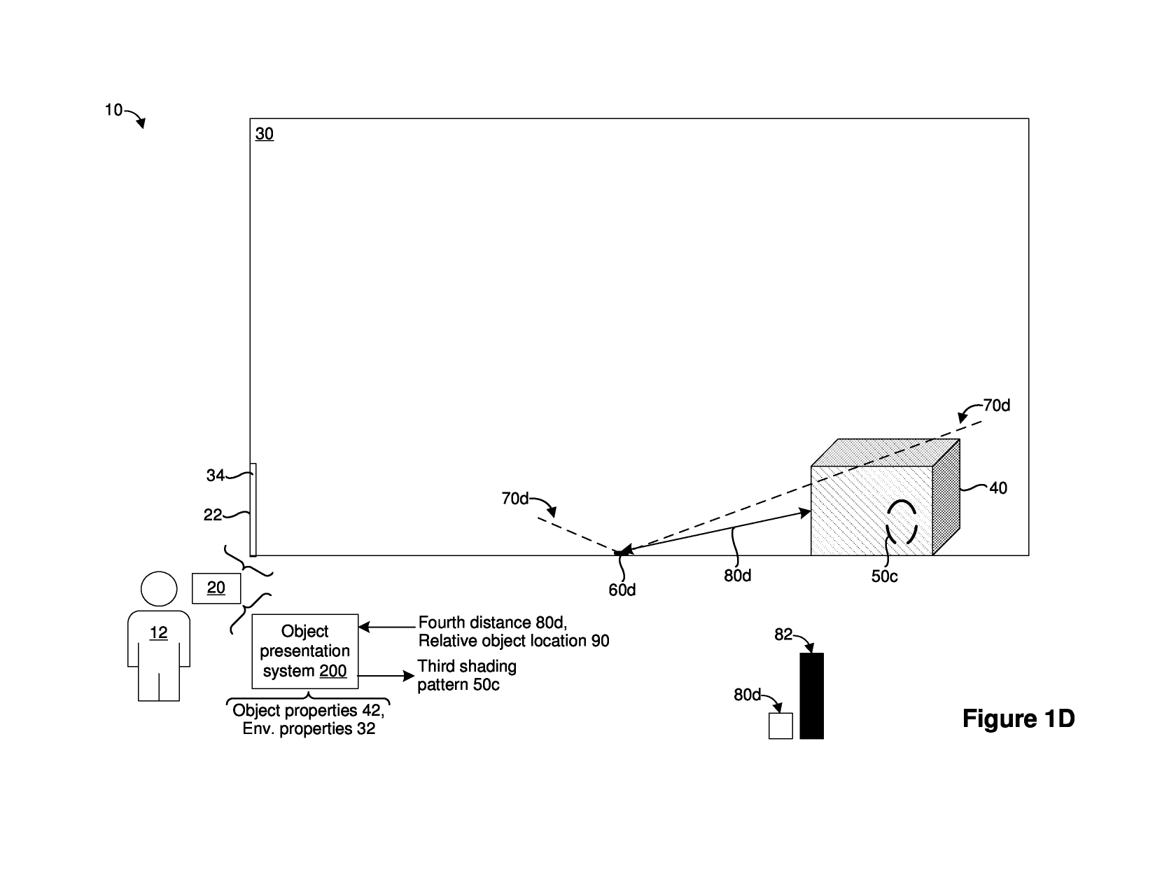

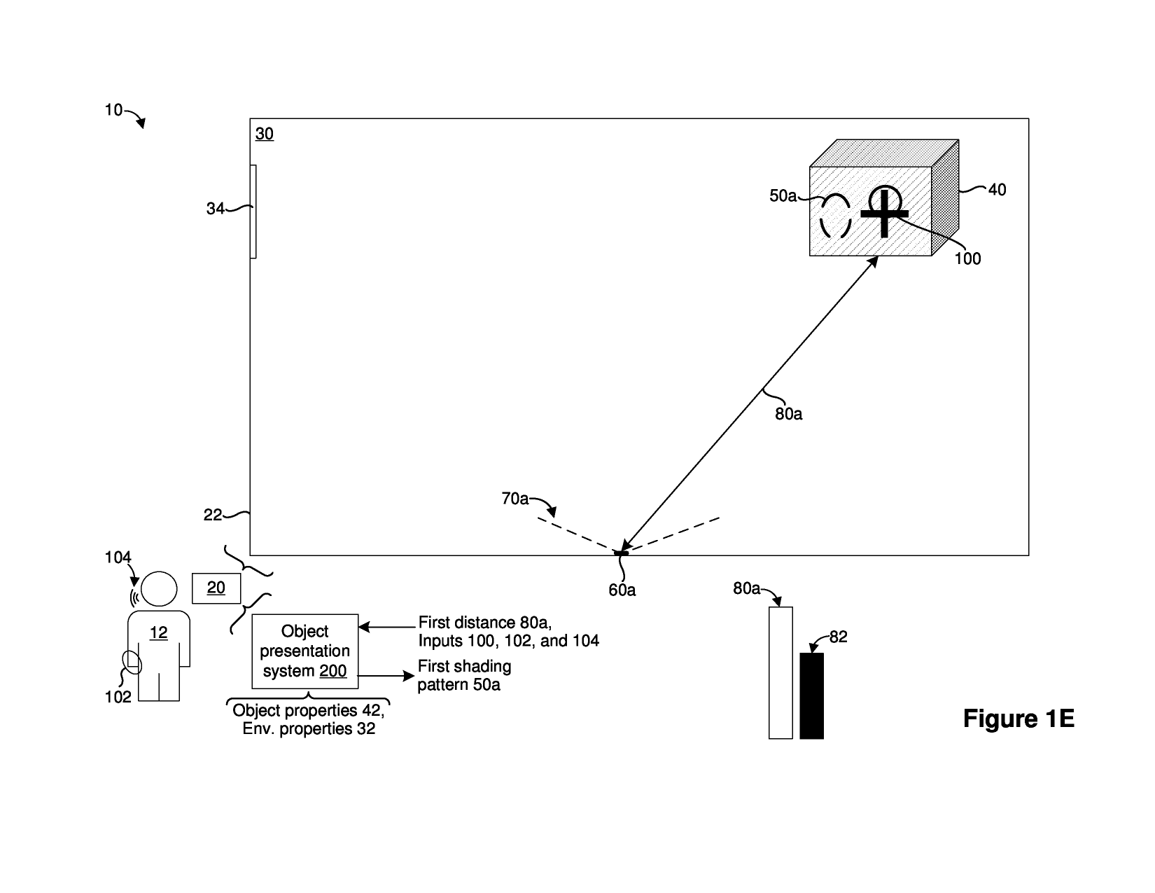

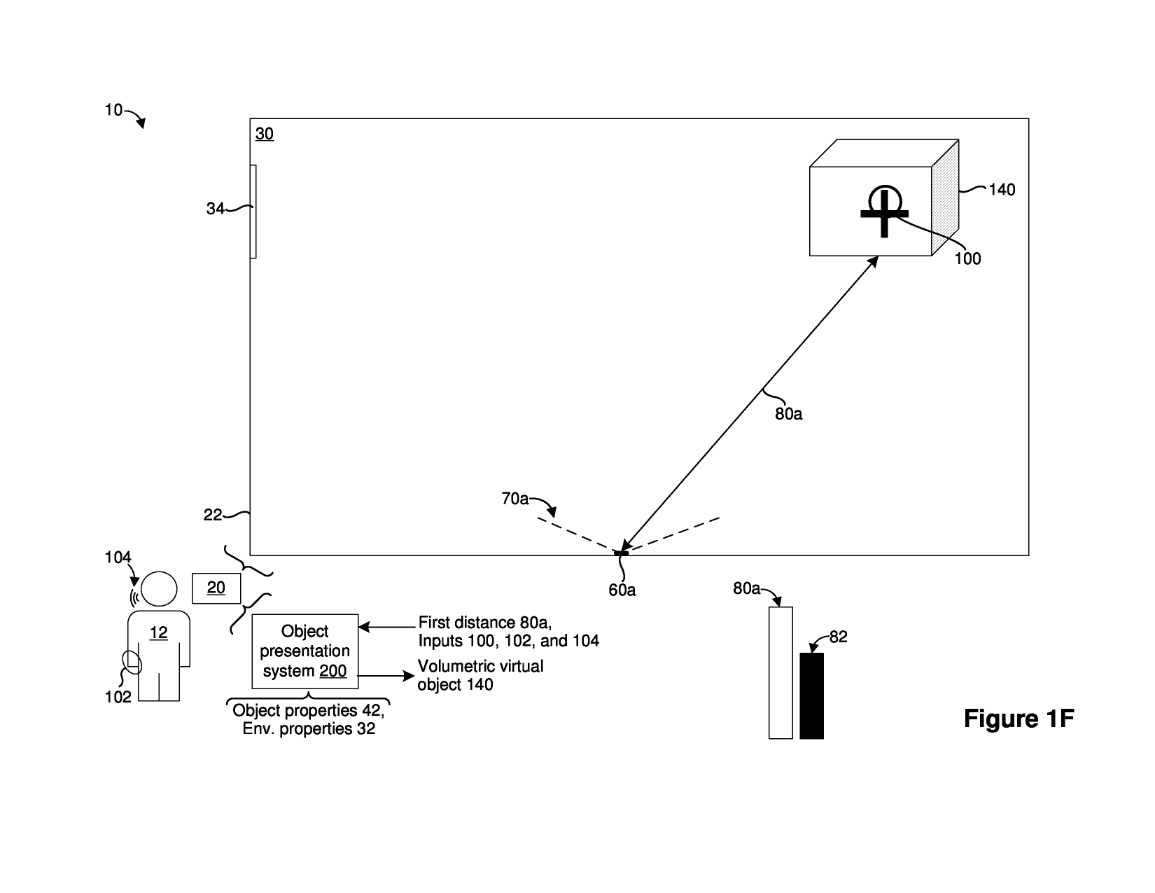

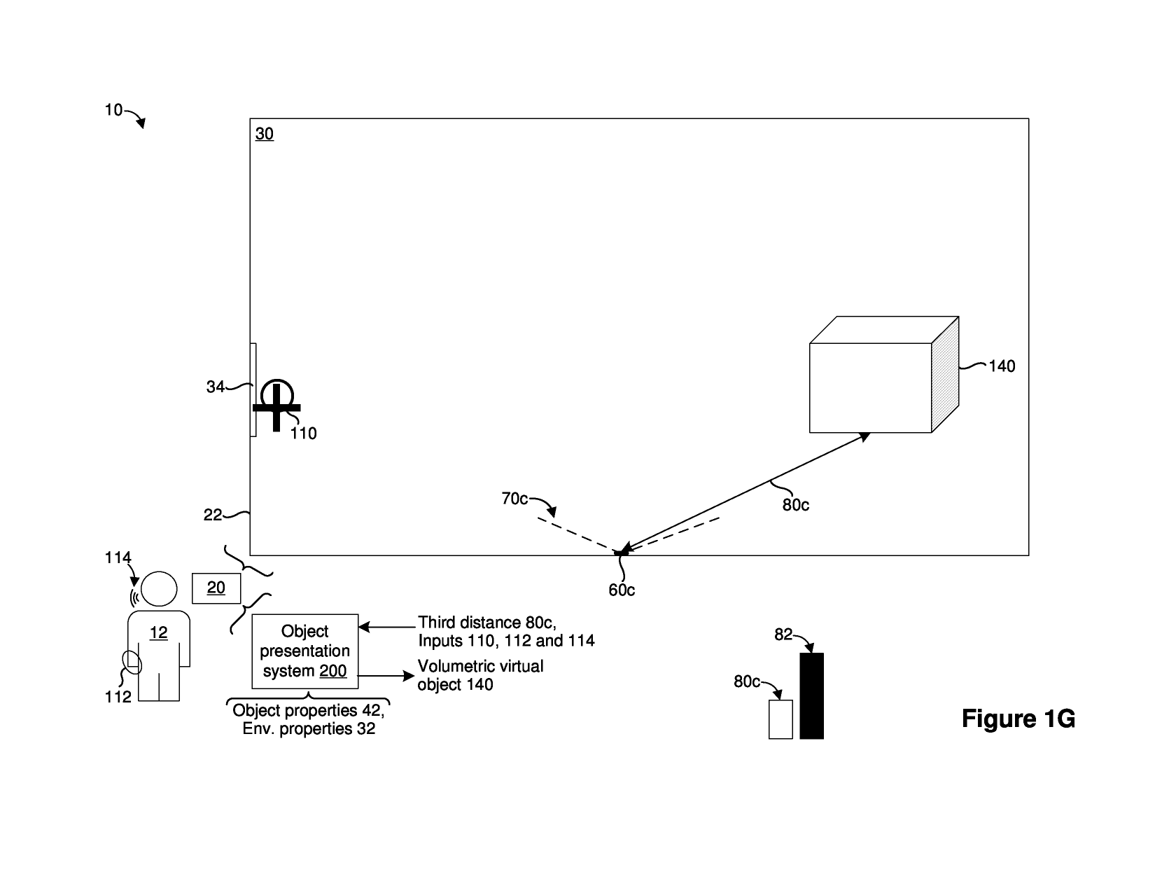

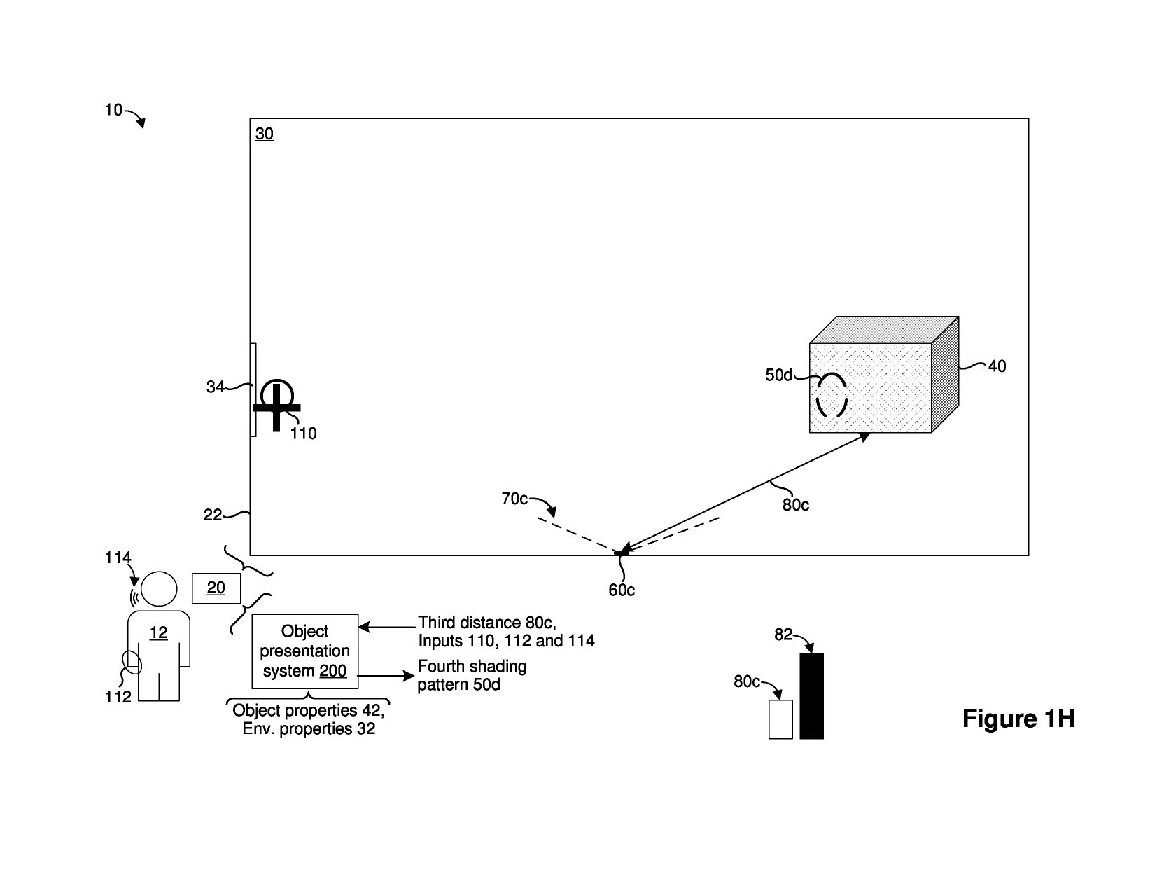

FIG. 1A is a diagram that illustrates an example physical environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. In various implementations, the physical environment 10 includes a user 12, an electronic device 20 (“device 20”, hereinafter for the sake of brevity) with a display 22, and an object presentation system 200 for displaying virtual objects on the display 22. In some implementations, the object presentation system 200 resides at the device 20. Alternatively, in some implementations, the object presentation system 200 resides at another device that is in electronic communication with the device 20. For example, the device 20 includes a head-mountable device (HMD) and the object presentation system 200 resides at a smartphone that is wirelessly connected with the HMD.

In the example of FIG. 1A, the device 20 displays an extended reality (XR) environment. In some implementations, the XR environment is a pass-through representation of the physical environment 10. Alternatively, in some implementations, the XR environment is a virtual environment 30. In the example of FIG. 1A, the virtual environment 30 includes a two-dimensional (2D) image 40 (“2D image 40”, hereinafter for the sake of brevity) of a three-dimensional (3D) virtual object (not shown). The object presentation system 200 displays the 2D image 40 with a first shading pattern 50a in order to provide an appearance that the 2D image 40 is the 3D virtual object that the 2D image 40 represents. The first shading pattern 50a makes the 2D image 40 resemble the 3D virtual object that the 2D image 40 represents. The first shading pattern 50a is indicated by rightward slanted hatching in FIG. 1A.

In the example of FIG. 1A, the device 20 displays the virtual environment 30 from a first user location 60a within the virtual environment 30. The first user location 60a corresponds to a first set of three-dimensional (3D) coordinates within the virtual environment 30. The first user location 60a is associated with a first point-of-view (POV) 70a. In the example of FIG. 1A, the first POV 70a is conical. Areas of the virtual environment 30 that are within the first POV 70a are visible to the user 12 while a remainder of the virtual environment 30 is not visible to the user 12. The first user location 60a is a first distance 80a from the 2D image 40. In some implementations, the device 20 identifies 3D coordinates of the 3D virtual object that the2D image 40 represents, and the first distance 80a represents a difference between the first user location 60a and the 3D coordinates of the 3D virtual object represented by the 2D image 40.

In some implementations, the first shading pattern 50a is a function of the first distance 80a. For example, as shown in FIG. 1A, the object presentation system 200 accepts a value representing the first distance 80a as an input and outputs parameter values corresponding to the first shading pattern 50a. In this example, the device 20 applies the parameter values corresponding to the first shading pattern 50a to the 2D image 40 in order to make the 2D image 40 simulate the appearance of a 3D virtual object from the first POV 70a. Applying the first shading pattern 50a to the 2D image 40 is less resource-intensive than displaying the 3D virtual object that the 2D image 40 represents. For example, displaying the 2D image 40 with the first shading pattern 50a reduces the need to invoke a 3D object renderer that renders 3D virtual objects thereby conserving graphics processing time and power that the 3D object renderer would consume. Hence, displaying the 2D image 40 with the first shading pattern 50a improves a functionality of the device 20 by reducing resource utilization, decreasing power consumption and lowering heat generation thereby allowing the user 12 to use the device 20 safely for an extended time duration.

In some implementations, the object presentation system 200 utilizes a shading model to generate the first shading pattern 50a. In some implementations, the shading model uses flat shading by applying a uniform shading across the 2D image 40. The object presentation system 200 can use flat shading when the 2D image 40 represents a relatively simple 3D virtual object with less than a threshold number of polygons. In some implementations, the shading model uses Gourad shading by calculating lighting at vertices and interpolating the shading across a surface connecting the vertices. In some implementations, the shading model uses Phong shading by calculating lighting at each pixel which results in a smoother and more accurate shading effect than flat shading or Gourad shading.

In some implementations, the object presentation system 200 determines the first shading pattern 50a based further on environment properties 32 that characterize the virtual environment 30. In some implementations, the environment properties 32 indicate a lighting level of the virtual environment 30. For example, the environment properties 32 indicate an ambient lighting level of the virtual environment 30, locations of light sources, intensities of light sources and/or colors of light emitted by the light sources. In the example of FIG. 1A, the virtual environment 30 includes a window 34. As such, the environment properties 32 may indicate an amount of virtual daylight entering from the window 34 and reaching the location of the 2D image 40. In some implementations, the object presentation system 200 (e.g., a shading model utilized by the object presentation system 200) accepts the environment properties 32 (e.g., a light intensity value, a light illumination angle, a light color, etc.) as additional inputs and generates the first shading pattern 50a based further on the environment properties 32.

In some implementations, the object presentation system 200 determines the first shading pattern 50a based further on object properties 42 that characterize the 3D virtual object that the 2D image 40 represents. In some implementations, the object properties 42 indicate a set of one or more colors of the 3D virtual object. In some implementations, the object properties 42 include a reflectivity value that indicates a reflectivity of the 3D virtual object (e.g., a shininess level of the 3D virtual object). In some implementations, the object properties 42 indicate a set of one or more materials that the 3D virtual object is constructed from (e.g., leather, wood, stone, etc.). In some implementations, the object properties 42 indicate a texture of the 3D virtual object (e.g., how it feels to touch the 3D virtual object, for example, a smoothness level or a roughness level of the 3D virtual object). In some implementations, the object presentation system 200 (e.g., the shading model utilized by the object presentation system 200) accepts the object properties 42 (e.g., color, reflectivity, materials, texture, etc.) as additional inputs and generates the first shading pattern 50a based further on the object properties 42.

In some implementations, a shading pattern is characterized by a set of parameter values for various parameters. In some implementations, a shading pattern is associated with a set of values for color parameters. The color parameters may include a base color which indicates a starting color of the shading pattern, an end color indicating a final color in a gradient-type shading pattern, and intermediate colors at specific points in a multi-stop gradient. In some implementations, a shading pattern is associated with gradient parameters for gradient shading. The gradient parameters may include a start point of the gradient, an end point of the gradient, gradient stops indicating specific points where specific colors are applied along the gradient, and gradient type such as linear, radial, conical or angular. In some implementations, a shading pattern is characterized by lighting parameters, for example, an ambient light intensity parameter indicating baseline illumination unaffected by object orientation, a diffuse light intensity parameter indicating light scattered uniformly across a surface, a specular light intensity parameter indicating light reflected in a specific direction causing highlights, a light source direction defining light’s origin or direction, and a shininess or Phong exponent indicating a sharpness of specular highlights. In some implementations, a shading pattern is characterized by texture parameters, opacity or transparency parameters, a reflectivity parameter, a refractivity parameters, pattern-specific parameters (e.g., frequency defining how often a pattern repeats, amplitude defining intensity of the pattern, phase offset defining shifts in pattern along an axis and noise level for procedural or stochastic patterns).

Referring to FIG. 1B, the device 20 presents (e.g., displays) the virtual environment 30 from a second user location 60b that provides a second POV 70b of the virtual environment 30. The second user location 60b corresponds to a second set of 3D coordinates within the virtual environment 30. The second user location 60b is different from the first user location 60a shown in FIG. 1A. For example, the second user location 60b is closer to the 2D image 40 than the first user location 60a. The second user location 60b is a second distance 80b from the 2D image 40.

The second distance 80b is greater than a threshold distance 82. In response to the second distance 80b being greater than the threshold distance 82, the object presentation system 200 determines to continue presenting the 2D image 40 instead of switching to displaying the 3D virtual object that the 2D image 40 represents. However, in order to provide an appearance that the 2D image 40 is a 3D virtual object, the object presentation system 200 determines a second shading pattern 50b for the 2D image 40 based on the second distance 80b. The device 20 applies the second shading pattern 50b to the 2D image 40 in order to maintain an appearance that the 2D image 40 is a 3D virtual object. As can be seen in FIG. 1B, the second distance 80b is less than the first distance 80a shown in FIG. 1A. A virtual representation of the user 12 (e.g., an avatar of the user 12 or a virtual character representing the user 12) within the virtual environment 30 may have moved from the first user location 60a shown in FIG. 1A to the second user location 60b shown in FIG. 1B. The second shading pattern 50b is indicated by cross hatching which is different from rightward slanted hatching representing the first shading pattern 50a shown in FIG. 1A.

Changing the shading pattern of the 2D image 40 from the first shading pattern 50a to the second shading pattern 50b maintains an illusion that the 2D image 40 is a 3D virtual object. Changing from the first shading pattern 50a to the second shading pattern 50b reduces the need to invoke a 3D object renderer that would consume more power and graphics computing resources than what is required to determine and apply the second shading pattern 50b to the 2D image 40. Therefore, determining and applying the second shading pattern 50b to the 2D image 40 improves a functionality of the device 40 by reducing heat generation associated with 3D object rendering and extending a battery life of the device 20 thereby allowing the user 12 to safely use the device 40 for an extended period of time.

Referring to FIG. 1C, the device 20 presents (e.g., displays) the virtual environment 30 from a third user location 60c that provides a third POV 70c of the virtual environment 30. The third user location 60c corresponds to a third set of 3D coordinates within the virtual environment 30. The third user location 60c is different from the first user location 60a and the second user location 60b. For example, the third user location 60c is closer to a location corresponding to the 3D virtual object than the first user location 60a and the second user location 60b. The third user location 60c is a third distance 80c from the location corresponding to the 3D virtual object. The object presentation system 200 switches from displaying the 2D image 40 to displaying a 3D virtual object 140 that the 2D image 40 represents in response to the third distance 80c being less than the threshold distance 82.

When the third distance 80c is less than the threshold distance 82, it becomes increasingly difficult to maintain the illusion of the 2D image 40 being a 3D virtual object. As such, switching to displaying the 3D virtual object 140 provides a better user experience than displaying the 2D image 40 shown in FIGS. 1A and 1B. Displaying the 3D virtual object 140 may require invoking a 3D object renderer which consumes additional graphics processing resources and power, and generates additional heat in comparison to displaying the 2D image 40. However, by delaying the presentation of the 3D virtual object 140 until the user 12 is within the threshold distance 82 of the 3D virtual object 140, the device 20 conserves scarce graphics computing resources and power, and reduces heat generation thereby enhancing a functionality of the device 20 by allowing the user 12 to use the device 20 for an extended period of time in a safe manner.

Referring to FIG. 1D, the device 20 presents (e.g., displays) the virtual environment 30 from a fourth user location 60d that provides a fourth POV 70d of the virtual environment 30. The fourth user location 60d corresponds to a fourth set of 3D coordinates within the virtual environment 30. The fourth user location 60d is different from the first user location 60a, the second user location 60b and the third user location 60c. For example, the fourth user location 60d is even closer to a location corresponding to the 3D virtual object than the first user location 60a, the second user location 60b and the third user location 60c. The fourth user location 60d is a fourth distance 80d from the location corresponding to the 3D virtual object that the 2D image 40 represents.

In some implementations, even though the fourth distance 80d is less than the threshold distance 82, the object presentation system 200 switches from displaying the 3D virtual object 140 to the 2D image 40 based on a relative object location 90 of the 3D virtual object 140. The relative object location 90 indicates a location of the 3D virtual object 140 relative to (e.g., within) the current POV. For example, the relative object location 90 indicates that the 3D virtual object 140 is in a periphery of the fourth POV 70d. Since the 3D virtual object 140 is within a peripheral vision area of the user 12 and not a central vision area of the user 12, the object presentation system 200 switches from displaying the 3D virtual object 140 to displaying the 2D image 40. If the object presentation system 200 displayed the 3D virtual object 140, then most of the 3D virtual object 140 would be out of the fourth POV 70d. Since the 3D virtual object 140 is in the periphery of the fourth POV 70d, it is unlikely that the user 12 is viewing the 3D virtual object 140. As such, switching from displaying the 3D virtual object 140 to displaying the 2D image 40 with a third shading pattern 50c that is based on the fourth distance 80d uses fewer computing resources and results in less heat generation than displaying the 3D virtual object 140.

Referring to FIGS. 1E and 1F, in some implementations, the object presentation system 200 switches from displaying the 2D image 40 to displaying the 3D virtual object 140 based on a user input directed to the 2D image 40. In some implementations, the user input includes a gaze input 100 that is directed to the 2D image 40. In some implementations, when the user 12 is gazing at the 2D image 40, the object presentation system 200 replaces the 2D image 40 with the 3D virtual object 140 as shown in FIG. 1F. In some implementations, the user input includes a gesture input 102 that is directed to the 2D image 40. For example, the gesture input 102 may include a pinch-and-drag gesture (e.g., a request to re-size the 3D virtual object 140 or a request to bring the 3D virtual object closer). In some implementations, when the user 12 gestures at the 2D image 40, the object presentation system 200 replaces the 2D image 40 with the 3D virtual object 140 as shown in FIG. 1F. In some implementations, the user input includes a verbal command 104 that is directed at the 2D image 40. For example, the user 12 may say “rotate” while gazing at the 2D image 40 indicating a desire to rotate the 3D virtual object 140. In some implementations, when the device 20 detects the verbal command 104 directed at the 2D image 40, the object presentation system 200 replaces the 2D image 40 with the 3D virtual object 140 as shown in FIG. 1F. The user inputs 100, 102 and 104 indicate a user interaction with the 2D image 40. Replacing the 2D image 40 with the3D virtual object 140 in response to detecting the user interaction with the 2D image 40 enhances a user experience by providing the more interactable (e.g., rotatable, moveable or animatable) 3D virtual object 140 instead of the static (e.g., not interactable, for example, nonrotating, nonmoving or inanimate) 2D image 40. In some implementations, the object presentation system 200 switches from displaying the 2D image 40 to displaying the 3D virtual object 140 based on a user interaction with the 2D image 40 even when the user 12 is not within the threshold distance 82 of the 2D image 40.

Referring to FIGS. 1G and 1H, in some implementations, the object presentation system 200 switches from displaying the 3D virtual object 140 to displaying the 2D image 40 based on a user input directed away from the 3D virtual object 140 or to another object within the virtual environment 30. In some implementations, the user input includes a gaze input 110 that is directed away from the 3D virtual object 140 (e.g., towards the window 34). In some implementations, when the user 12 is gazing away from the 3D virtual object 140, the object presentation system 200 replaces the 3D virtual object 140 with the 2D image 40 as shown in FIG. 1H. In some implementations, the user input includes a gesture input 112 that is directed away from the 3D virtual object 140. For example, the gesture input 112 may include a pinch-and-drag gesture directed at a window shade covering the window 34 (e.g., a request to open or close the window shade). In some implementations, when the user 12 gestures at another object, the object presentation system 200 replaces the 3D virtual object 140 with the 2D image 40 as shown in FIG. 1H. In some implementations, the user input includes a verbal command 114 that is directed away from the 3D virtual object 140 (e.g., towards another object in the virtual environment, for example, towards the window shade covering the window 34). For example, the user 12 may say “open” while gazing at the window shade covering the window 34. In some implementations, when the device 20 detects the verbal command 114 directed away from the 3D virtual object 140, the object presentation system 200 replaces the 3D virtual object 140 with the 2D image 40 as shown in FIG. 1H. The user inputs 110, 112 and 114 indicate a lack of user interaction with the 3D virtual object 140. Replacing the 3D virtual object 140 with the 2D image 40 in response to a lack of user interaction with the 3D virtual object 40 for a threshold amount of time conserves graphics computing resources and reduces heat generation thereby enhancing a functionality of the device 20. In some implementations, the object presentation system 200 switches from displaying the 3D virtual object 140 to displaying the 2D image 40 based on a lack of user interaction with the 3D virtual object 140 even when the user 12 is within the threshold distance 82 of the 3D virtual object 140.

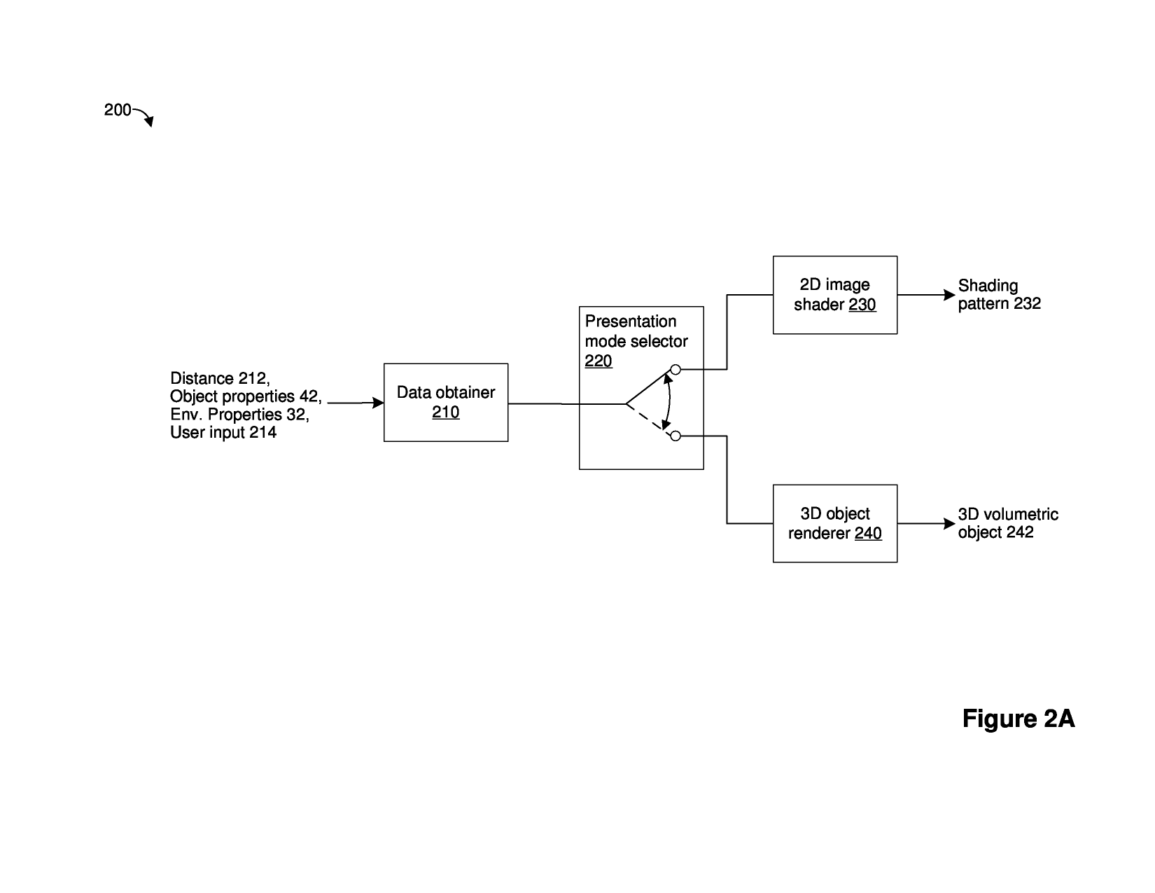

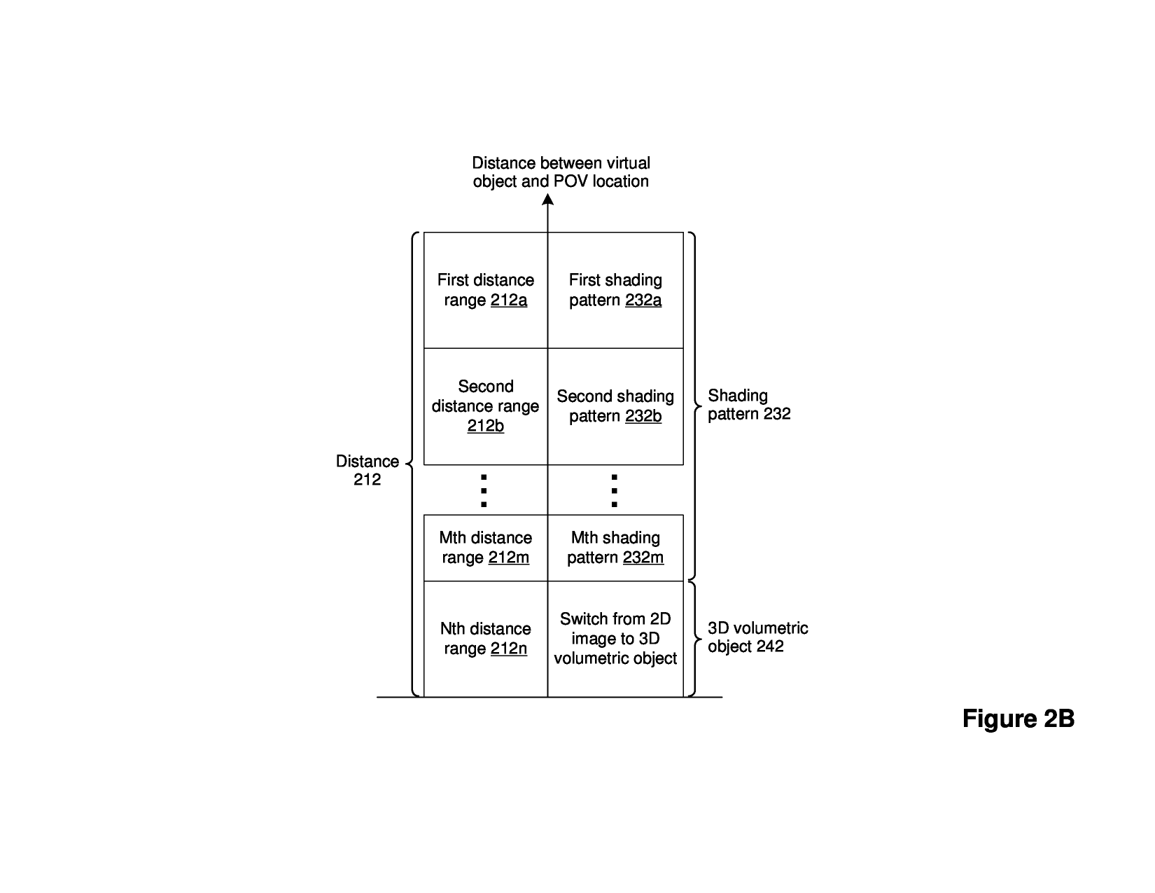

FIG. 2A is a block diagram of the object presentation system 200 in accordance with some implementations. In some implementations, the object presentation system 200 includes a data obtainer 210, a presentation mode selector 220, a 2D image shader 230 and a 3D object renderer 240.

In various implementations, the data obtainer 210 obtains a distance 212 between a POV location and a 3D virtual object (e.g., the first distance 80a shown in FIG. 1A, the second distance 80b shown in FIG. 1B, the third distance 80c shown in FIG. 1C, and the fourth distance 80d shown in FIG. 1D). The data obtainer 210 obtains the environment properties 32 and the object properties 42. The data obtainer 210 obtains a user input 214 (e.g., the gaze input 100, the gesture input 102 and the verbal command 104 shown in FIGS. 1E-1F, and the gaze input 110, the gesture input 112 and the verbal command 114 shown in FIGS. 1G-1H).

In various implementations, the presentation mode selector 220 selects between a 2D presentation mode and a 3D presentation mode based on the data obtained by the data obtainer 210. As described in relation to FIGS. 1A-1C, the presentation mode selector 220 selects the 2D presentation mode when the distance 212 is greater than a threshold (e.g., the threshold distance 82 shown in FIGS. 1B and 1C). The presentation mode selector 220 switches from the 2D presentation mode to the 3D presentation mode when the distance 212 decreases to a value that is below the threshold (e.g., as shown in FIG. 1C). As described in relation to FIGS. 1E-1H, in some implementations, the presentation mode selector 220 selects between the 2D presentation mode and the 3D presentation mode based on the user input 214. For example, as described in relation to FIGS. 1E-1F, the presentation mode selector 220 switches from the 2D presentation mode to the 3D presentation mode when the user input 214 is directed to the 2D image. As another example, as described in relation to FIGS. 1G-1H, the presentation mode selector 220 switches from the 3D presentation mode to the 2D presentation mode when the user input 214 is directed away from the 3D virtual object.

The 2D image shader 230 determines a shading pattern 232 to apply to a 2D image in the 2D presentation mode. For example, the 2D image shader 230 determines the first shading pattern 50a shown in FIG. 1A and the second shading pattern 50b shown in FIG. 1B. As described herein, the 2D image shader 230 utilizes a shading model to generate the shading pattern 232. To that end, the 2D image shader 230 may utilize some of the data obtained by the data obtainer 210 to determine the shading pattern 232. For example, in some implementations, the shading pattern 232 is a function of the environment properties 32 (e.g., lighting levels, illumination angle, light color, etc.) and/or the object properties 42 (e.g., object colors, reflectivity, materials, textures, etc.).

The 3D object renderer 240 is invoked when the presentation mode selector 220 selects the 3D presentation mode. The 3D object renderer 240 generates a 3D volumetric object 242 (e.g., the 3D virtual object 140 shown in FIG. 1C). The 3D object renderer 240 tends to consume more graphics computing resources than the 2D image shader 230 and the 3D object renderer 240 tends to result in greater heat generation than the 2D image shader 230. Hence, the devices, methods and systems described herein reduce an amount of time that the 3D object renderer 240 is invoked and increase an amount of time that the 2D image shader 230 is invoked.

FIG. 2B illustrates selection of presentation modes and application of various shading patterns based on the distance 212. When the distance 212 is within a first distance range 212a, the presentation mode selector 220 selects the 2D presentation mode and the 2D image shader 230 applies a first shading pattern 232a. When the distance 212 is within a second distance range 212b that is smaller than the first distance range 212a, the presentation mode selector 220 maintains selection of the 2D presentation mode and the 2D image shader 230 switches from the first shading pattern 232a to a second shading pattern 232b in order to maintain the illusion of presenting a 3D virtual object. When the distance 212 is within an mth distance range 212m that is smaller than the first distance range 212a, the second distance range 212b and other preceding distance ranges, the presentation mode selector 220 maintains selection of the2D presentation mode and the 2D image shader 230 switches to an mth shading pattern 232m in order to maintain the illusion of presenting a 3D virtual object. When the distance 212 is within an nth distance range 212n that is smaller than the first distance range 212a, the second distance range 212b, …, and the mth distance range 212m, the presentation mode selector 220 switches from the 2D presentation mode to the 3D presentation mode and the 3D object renderer 240 displays the 3D volumetric object 242.

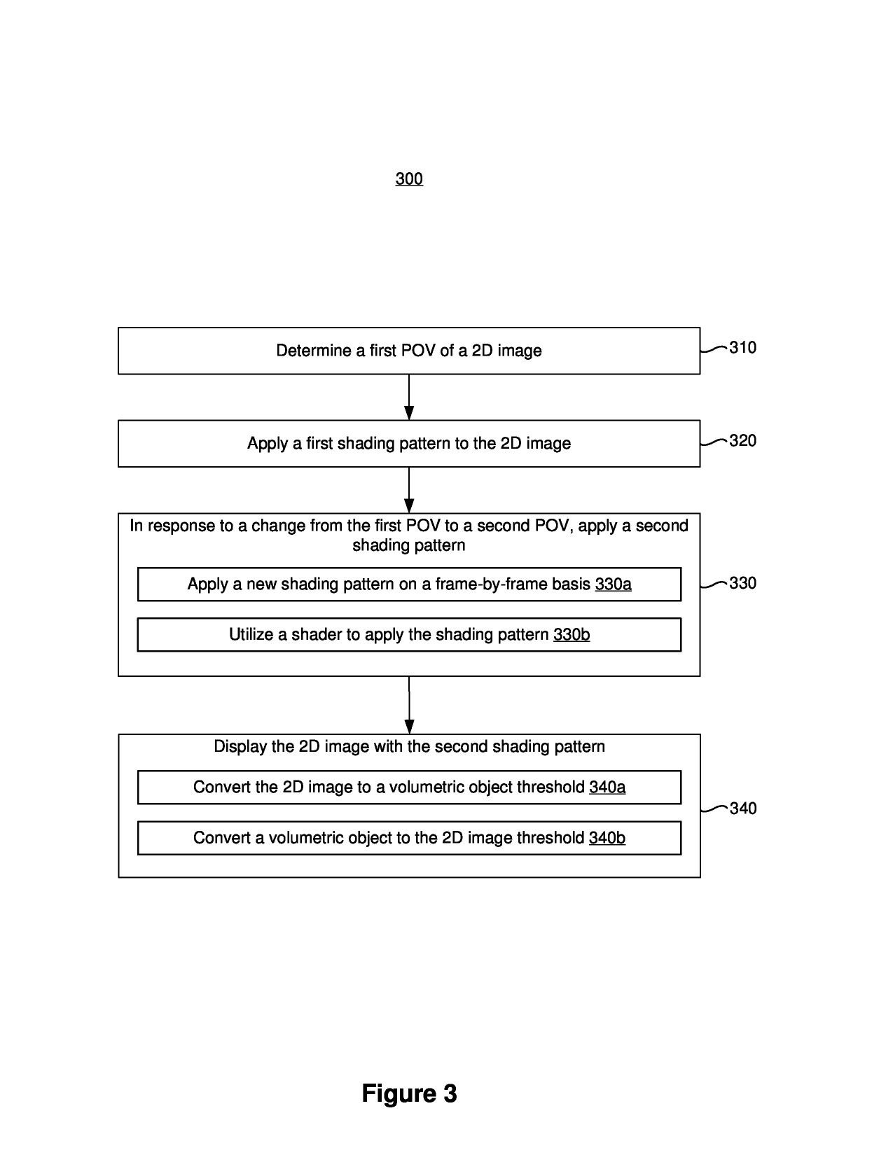

FIG. 3 is a flowchart representation of a method 300 for dynamically shading a 2D image representing a 3D virtual object. In various implementations, the method 300 is performed by a device including a display, a non-transitory memory and one or more processors coupled with the display and the non-transitory memory (e.g., the device 20 shown in FIGS. 1A-1H and/or the object presentation system 200 shown in FIGS. 1A-2). In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in various implementations, the method 300 includes determining a first point-of-view (POV) of a two-dimensional (2D) image in a virtual environment from a user location characterized by a set of coordinates in the virtual environment and a distance between the 2D image and the user location. For example, as shown in FIG. 1A, the device 20 displays the virtual environment 30 from the first POV 70a.

As represented by block 320, in various implementations, the method 300 includes applying a first shading pattern to the 2D image based on the first POV in order to make the 2D image appear as a three-dimensional (3D) virtual object from the first POV. For example, as shown in FIG. 1A, the object presentation system 200 applies the first shading pattern 50a to the 2D image 40 based on the first distance 80a.

As represented by block 330, in some implementations, the method 300 includes, in response to a change from the first POV to a second POV, determining a second shading pattern based on the second POV in order to make the 2D image appear as the 3D virtual object from the second POV. For example, as shown in FIG. 1B, the object presentation system 200 determines the second shading pattern 50b for the 2D image 40 based on the second distance 80b.

As represented by block 330a, in some implementations, the method 300 includes applying a new shading pattern to the 2D image on a frame-by-frame basis. For example, as the POV changes or environment conditions change across a sequence of frames, the device determines and applies other shading patterns that are more suitable for the changing POV and environment conditions.

As represented by block 330b, in some implementations, the method 300 includes utilizing a shader to determine the first shading pattern and the second shading pattern. For example, as shown in FIG. 2A, the 2D image shader 230 determines the shading pattern 232. In some implementations, the first shading pattern and the second shading pattern are a function of a lighting condition of the virtual environment. For example, as described in relation to FIG. 2A, the shading pattern 232 is a function of the environment properties 32.

As represented by block 340, in some implementations, the method 300 includes displaying, on the display, the 2D image with the second shading pattern. For example, as shown in FIG. 1C, the device 20 displays the 2D image 40 with the second shading pattern 50b. As described herein, applying the second shading pattern is computationally cheaper than rendering a3D virtual object while maintaining the illusion of displaying the 3D virtual object thereby providing a great user experience without having to utilize excess computational resources.

As represented by block 340a, in some implementations, the method 300 includes converting the 2D image to a volumetric virtual object when the distance between the user location and the 2D image breaches a threshold. For example, as shown in FIG. 1C, the object presentation system 200 switches from displaying the 2D image 40 to displaying the 3D virtual object 140 when the third distance 80c is less than the threshold distance 82.

In some implementations, the method 300 includes converting the 2D image to a volumetric virtual object in response to interactions with a portion of the 2D image. In some implementations, the method 300 includes converting the 2D image to a volumetric virtual object in response to a gaze input. For example, as shown in FIGS. 1E-1F, the device 20 switches from displaying the 2D image 40 to displaying the 3D virtual object 140 based on a combination of the inputs 100, 102 and 104.

As represented by block 340b, in some implementations, the method 300 includes converting a volumetric virtual object to the 2D image when the distance between the user location and the volumetric virtual object breaches a threshold. For example, the device switches from displaying the volumetric virtual object to displaying the 2D image when the distance between the volumetric virtual object and the user location increases beyond the threshold distance 82 shown in FIGS. 1B and 1C.

In some implementations, the method 300 includes converting a volumetric virtual object to the 2D image in response to a lack of interactions for a threshold amount of time. In some implementations, the method 300 includes converting the 2D image to a volumetric virtual object in response to a gaze input. For example, referring to FIGS. 1G-1H, the device 20 switches from displaying the 3D virtual object 140 to displaying the 2D image 40 based on a combination of the inputs 110, 112 and 114.

In some implementations, the method 300 includes converting a volumetric virtual object to the 2D image when the volumetric virtual object is in a periphery of a user of the device. For example, as shown in FIG. 1D, the device 20 switches from displaying the 3D virtual object 140 to displaying the 2D image 40 when the 3D virtual object 140 is in a peripheral vision of the user 12 instead of a central vision of the user 12.

In various implementations, the method 300 includes adjusting a set of one or more normal vectors associated with the 2D image in order to change a shading pattern associated with the 2D image. In some implementations, adjusting a normal vector of the 2D image automatically invokes a shading model (e.g., the 2D image shader 230 shown in FIG. 2A) that re-calculates how light interacts with the 2D image. An adjustment to the normal vector changes how light is reflected by the 2D image, and a change in how light is reflected by the 2D image changes the shading effect produced by the 2D image.

In various implementations, the method 300 includes adjusting a set of one or more geometric parameters associated with the 2D image. For example, in some implementations, the device changes a size and/or a position of a 2D object depicted in the 2D image in order to provide an appearance that the 2D object is a 3D object. As an example, the device adjusts (e.g., increases or decreases) a size of a geometric object (e.g., a cube) in order the enhance a 3D appearance of the geometric object. For example, the device expands a size of a cube and shifts adjacent geometry based on changes in perspective in order to make the cube appear as a 3D object.

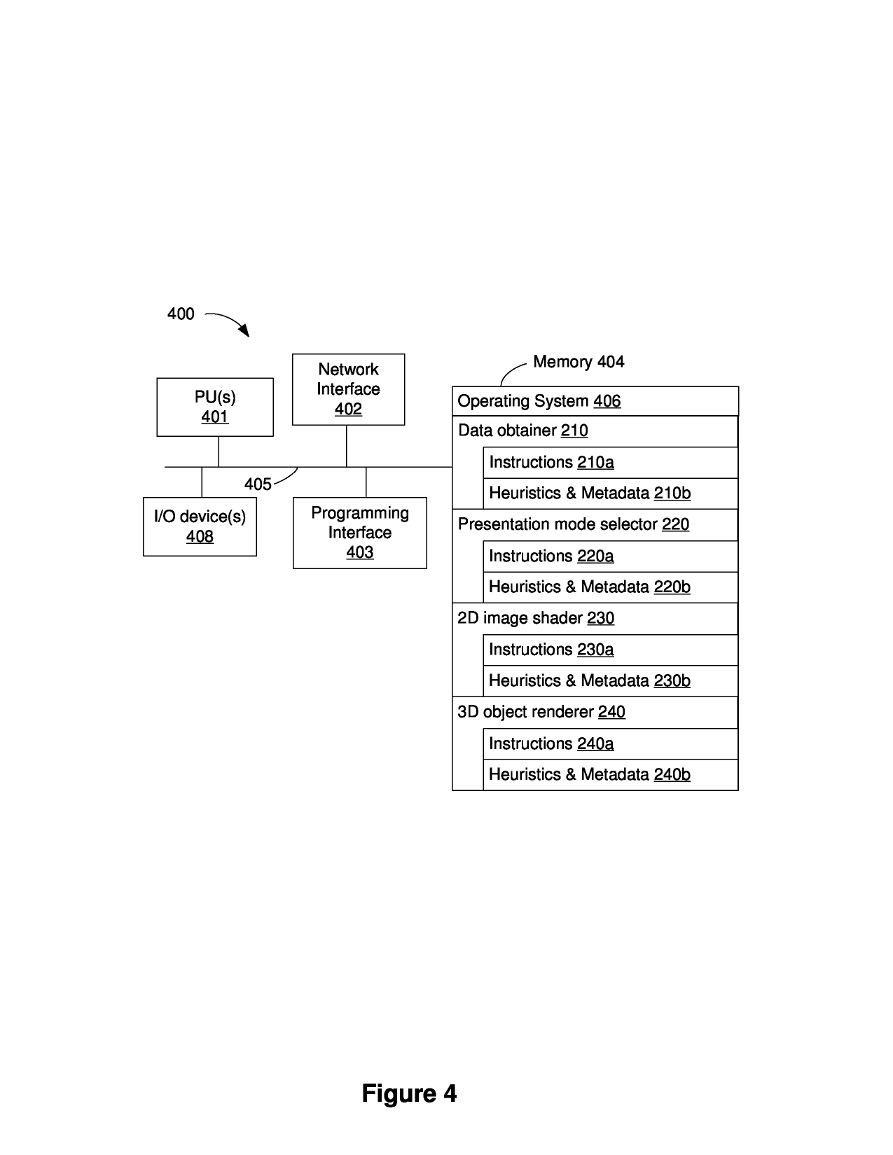

FIG. 4 is a block diagram of a device 400 in accordance with some implementations. In some implementations, the device 400 implements the device 20 shown in FIGS. 1A-1H and/or the object presentation system 200 shown in FIGS. 1A-2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (PUs) 401, a network interface 402, a programming interface 403, a memory 404, one or more input/output (I/O) devices 408, and one or more communication buses 405 for interconnecting these and various other components.

In some implementations, the PU(s) 401 includes one or more central processing units (CPU(s)), one or more graphics processing units (GPU(s)) and/or one or more neural processing units (NPU(s)).

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more PUs 401. The memory 404 comprises a non-transitory computer readable storage medium.

In some implementations, the memory 404 or the non-transitory computer readable storage medium of the memory 404 stores the following programs, modules and data structures, or a subset thereof including an optional operating system 406, the data obtainer 210, the presentation mode selector 220, the 2D image shader 230 and the 3D object renderer 240. In various implementations, the device 400 performs the method 300 shown in FIG. 3.

In some implementations, the data obtainer 210 includes instructions 210a, and heuristics and metadata 210b for obtaining data (e.g., the distance 212, the object properties 42, the environment properties 32 and the user input 214 shown in FIG. 2A). In some implementations, the data obtainer 210 performs at least some of the operation(s) represented by block 310 in FIG. 3.

In some implementations, the presentation mode selector 220 includes instructions 220a, and heuristics and metadata 220b for selecting between a 2D presentation mode and a 3D presentation mode.

In some implementations, the 2D image shader 230 includes instructions 230a, and heuristics and metadata 230b for determining and applying shading patterns (e.g., the shading patterns 50a and 50b shown in FIGS. 1A and 1B, respectively) to a 2D image in order to make the 2D image appear as a 3D virtual object. In some implementations, the 2D image shader 230 performs at least some of the operation(s) represented by blocks 320, 330 and 340 in FIG. 3.

In some implementations, the 3D object renderer 240 includes instructions 240a, and heuristics and metadata 240b for displaying a 3D virtual object (e.g., the 3D virtual object 140 shown in FIG. 1C).

In some implementations, the one or more I/O devices 408 include a set of one or more sensors for detecting user inputs. For example, the one or more I/O devices 408 include an eye tracker for detecting gaze inputs, a gesture tracker for detecting gestures and a microphone for detecting verbal commands.

In various implementations, the one or more I/O devices 408 include a video pass-through display which displays at least a portion of a physical environment surrounding the device 400 as an image captured by the camera. In various implementations, the one or more I/O devices 408 include an optical see-through display which is at least partially transparent and passes light emitted by or reflected off the physical environment.

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at a device including a non-transitory memory, an input device, a display and one or more processors:
determining a first point-of-view (POV) of a two-dimensional (2D) image in a virtual environment from a user location characterized by a set of coordinates in the virtual environment and a distance between the 2D image and the user location;
applying a first shading pattern to the 2D image based on the first POV in order to make the 2D image appear as a three-dimensional (3D) virtual object from the first POV;
in response to a change from the first POV to a second POV, determining a second shading pattern based on the second POV in order to make the 2D image appear as the 3D virtual object from the second POV; and
displaying, on the display, the 2D image with the second shading pattern.

2. The method of claim 1, further comprising applying a new shading pattern to the 2D image on a frame-by-frame basis.

3. The method of claim 1, further comprising converting the 2D image to a volumetric virtual object when the distance between the user location and the 2D image breaches a threshold.

4. The method of claim 1, further comprising converting a volumetric virtual object to the 2D image when the distance between the user location and the volumetric virtual object breaches a threshold.

5. The method of claim 1, further comprising converting the 2D image to a volumetric virtual object in response to interactions with a portion of the 2D image.

6. The method of claim 1, further comprising converting a volumetric virtual object to the 2D image in response to a lack of interactions for a threshold amount of time.

7. The method of claim 1, further comprising converting the 2D image to a volumetric virtual object in response to a gaze input.

8. The method of claim 1, further comprising converting a volumetric virtual object to the 2D image when the volumetric virtual object is in a periphery of a user of the device.

9. The method of claim 1, further comprising utilizing a shader to determine the first shading pattern and the second shading pattern.

10. The method of claim 1, wherein the first shading pattern and the second shading pattern are a function of a lighting condition of the virtual environment.

11. A device comprising:
a non-transitory memory;
an input device;
a display; and
one or more processors to:
determine a first point-of-view (POV) of a two-dimensional (2D) image in a virtual environment from a user location characterized by a set of coordinates in the virtual environment and a distance between the 2D image and the user location;
apply a first shading pattern to the 2D image based on the first POV in order to make the 2D image appear as a three-dimensional (3D) virtual object from the first POV;
in response to a change from the first POV to a second POV, determine a second shading pattern based on the second POV in order to make the 2D image appear as the 3D virtual object from the second POV; and
display, on the display, the 2D image with the second shading pattern.

12. The device of claim 11, wherein the one or more processors are further to apply a new shading pattern to the 2D image on a frame-by-frame basis.

13. The device of claim 11, wherein the one or more processors are further to convert the 2D image to a volumetric virtual object when the distance between the user location and the 2D image breaches a threshold.

14. The device of claim 11, wherein the one or more processors are further to convert a volumetric virtual object to the 2D image when the distance between the user location and the volumetric virtual object breaches a threshold.

15. The device of claim 11, wherein the one or more processors are further to convert the 2D image to a volumetric virtual object in response to interactions with a portion of the 2D image.

16. The device of claim 11, wherein the one or more processors are further to convert a volumetric virtual object to the 2D image in response to a lack of interactions for a threshold amount of time.

17. The device of claim 11, wherein the one or more processors are further to convert the 2D image to a volumetric virtual object in response to a gaze input.

18. The device of claim 11, wherein the one or more processors are further to convert a volumetric virtual object to the 2D image when the volumetric virtual object is in a periphery of a user of the device.

19. The device of claim 11, wherein the first shading pattern and the second shading pattern are a function of a lighting condition of the virtual environment.

20. A non-transitory memory storing one or more programs, which, when executed by one or more processors of a device including an input device and a display, cause the device to:
determine a first point-of-view (POV) of a two-dimensional (2D) image in a virtual environment from a user location characterized by a set of coordinates in the virtual environment and a distance between the 2D image and the user location;
apply a first shading pattern to the 2D image based on the first POV in order to make the 2D image appear as a three-dimensional (3D) virtual object from the first POV;
in response to a change from the first POV to a second POV, determine a second shading pattern based on the second POV in order to make the 2D image appear as the 3D virtual object from the second POV; and
display, on the display, the 2D image with the second shading pattern.
